(19) United States
(12) Patent Application Publication
(10) Pub. No.: US 2026/0210858 A1
(43) Pub. Date: Jul. 23, 2026

(54) WEARABLE OPTICAL ANALYTE SENSOR

(71) Applicant: Solventum Intellectual Properties Company, Maplewood, MN (US)

(72) Inventors: Przemyslaw P. MARKOWICZ, Maplewood, MN (US); Francis T. CARUSO, Maplewood, MN (US); Leif J. ERICKSON, Maplewood, MN (US); Neeraj SHARMA, Maplewood, MN (US); Mark A. ROEHRIG, Maplewood, MN (US); Jason W. BJORK, Maplewood, MN (US); Bharat R. ACHARYA, Maplewood, MN (US); Dawn V. MUYRES, Maplewood, MN (US)

(73) Assignee: Solventum Intellectual Properties Company, Maplewood, MN (US)

(21) Appl. No.: 19/136,101

(22) PCT Filed: Nov. 20, 2023
(86) PCT No.: PCT/IB2023/061696

§ 371 Date: Jun. 5, 2025

Related U.S. Application Data
(60) Provisional application No. 63/387,774, filed on Dec. 16, 2022.

(51) Int. Cl. G01N 21/64; G01N 21/78

(52) U.S. Cl. CPC G01N 21/6456; G01N 21/783; G01N 2021/6471; G01N 2201/0221; G01N 2201/0626

(57) ABSTRACT

A wearable optical analyte sensor includes a pixelated image sensor; an analyte-sensitive photoluminescent layer; an extended illumination source disposed between the analyte-sensitive photoluminescent layer and the pixelated image sensor; and an optical filter disposed between the extended illumination source and the pixelated image sensor. Each of the analyte-sensitive photoluminescent layer and the optical filter cover at least a same first pixelated imaging area of the pixelated image sensor. The wearable optical analyte sensor can be integrated in a wound dressing. A system can include the wearable optical analyte system and a processor in communication with the pixelated image sensor and configured to determine the presence of an analyte.

### TECHNICAL FIELD

The present description relates generally to wearable optical analyte sensors and to wound dressings and sensors including optical analyte sensors.

### BACKGROUND

Phosphorescent oxygen sensors are known.

### SUMMARY

In some aspects, the present description provides a wearable optical analyte sensor including a pixelated image sensor; an analyte-sensitive photoluminescent layer; an extended illumination source disposed between the analyte-sensitive photoluminescent layer and the pixelated image sensor; and an optical filter disposed between the extended illumination source and the pixelated image sensor. Each of the analyte-sensitive photoluminescent layer and the optical filter cover at least a same first pixelated imaging area of the pixelated image sensor. The optical filter can be or include a wavelength-selective optical filter and/or an angular light control filter. The wearable optical analyte sensor can be integrated in a wound dressing. A system can include the wearable optical analyte system and a processor in communication with the pixelated image sensor and configured to determine the presence of an analyte.

In some aspects, the present description provides a wearable optical analyte sensor including a pixelated image sensor; an analyte-sensitive photoluminescent layer; an extended illumination source disposed between the analyte-sensitive photoluminescent layer and the pixelated image sensor; and a wavelength-selective optical filter disposed between the extended illumination source and the pixelated image sensor. Each of the analyte-sensitive photoluminescent layer and the wavelength-selective optical filter cover at least a same first pixelated imaging area of the pixelated image sensor. In some embodiments, an angular light control filter is disposed between the extended illumination source and the pixelated image sensor. Systems and wound dressings that include the wearable optical analyte sensors are also provided.

In some aspects, the present description provides a wearable optical analyte sensor including a plurality of optical elements stacked on one another along a common stacking direction. The plurality of optical elements includes an optical sensor configured to detect light incident on the optical sensor along the stacking direction; an analyte-sensitive photoluminescent layer; an illumination source disposed between the analyte-sensitive photoluminescent layer and the optical sensor; and an angular light control filter disposed between the illumination source and the optical sensor. In some embodiments, the plurality of optical elements includes a wavelength-selective optical filter disposed between the illumination source and the optical sensor. In some embodiments, the optical sensor is or includes a pixelated image sensor. Systems and wound dressings that include the wearable optical analyte sensors are also provided.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-section view of a system, a wound dressing, and a wearable optical analyte sensor, according to some embodiments.

FIG. 2 is a schematic exploded view of wearable optical analyte sensor, according to some embodiments.

FIG. 3 is a schematic top plan view of a wearable optical analyte sensor or a portion of a wearable optical analyte sensor, according to some embodiments.

FIG. 4 is a schematic cross-sectional view of a wound dressing including a wearable optical analyte sensor, according to some embodiments.

FIG. 5 is a schematic cross-sectional view of an article bent around a cylinder, according to some embodiments.

FIG. 6A is a schematic cross-sectional view of a wearable optical analyte sensor including an illumination source including a plurality micro-light-emitting diodes, according to some embodiments.

FIG. 6B is a schematic top view of the illumination source of FIG. 6A, according to some embodiments.

FIG. 7A is a schematic cross-sectional view of a wearable optical analyte sensor including an illumination source including a ring light guide, according to some embodiments.

FIG. 7B is a schematic top plan view of the illumination source of FIG. 7A, according to some embodiments.

FIG. 8 is a schematic cross-sectional view of a wavelength-selective optical filter, according to some embodiments.

FIG. 9 is a schematic cross-sectional view of a wearable optical analyte sensor including an angular light control filter, according to some embodiments.

FIG. 10A is a schematic cross-section view of an angular light control filter, according to some embodiments.

FIG. 10B is a schematic top perspective view of a plurality of microlenses of the angular light control filter of FIG. 10A, according to some embodiments.

FIG. 11A is an image determined using an optical analyte sensor in nitrogen with an angular light control filter, according to some embodiments.

FIG. 11B is an image determined using an optical analyte sensor in air with an angular light control filter, according to some embodiments.

FIG. 11C is an image determined using an optical analyte sensor in nitrogen without an angular light control filter, according to some embodiments.

FIG. 12 is a plot of an amplitude of a signal determined across a photoluminescent pattern produce by illumination with an ultraviolet (UV) light patterned using a resolution mask, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

In a clinical setting, it may be desired to monitor a patient's health by measuring tissue gas levels. It can be desired to monitor tissue gas such as oxygen or other analytes using a wearable device such as oxygen sensing wound dressing. According to some embodiments, a wearable optical analyte sensor is provided that utilizes an optical sensor to detect photoluminescence (e.g., phosphorescence) from an analyte-sensitive photoluminescent material, for example. Optical filter(s) can be provided to prevent light used to stimulate the photoluminescent material from reaching the optical sensor and/or to improve contrast and resolution of photoluminescence detected by the optical sensor. For example, a wavelength selective optical filter can be utilized to block the light used to stimulate the photoluminescent material and transmit photoluminescent light. As another example, an angular light control filter can be utilized to transmit approximately normally incident light while blocking obliquely incident light. Such angular light control filters have been found to improve a resolution of the wearable optical analyte sensor and/or to allow a greater separation (e.g., to allow for additional layers or components) between the analyte-sensitive photoluminescent material and the optical sensor while still achieving a desired resolution. For example, the optical sensor receiving the photoluminescent light can be a pixelated image sensor and the detected 20 image can be used to determine a two-dimensional distribution of the analyte across a surface of the wearable optical analyte sensor. It has been found that including an angular light control filter can improve the resolution of the two-dimensional distribution determined by the wearable optical analyte sensor. An advantage of the wearable optical analyte sensor, according to some embodiments, is that the environment (e.g., the oxygen distribution) underneath a wound dressing can be directly monitored at high resolution without needing to record pictures with external devices.

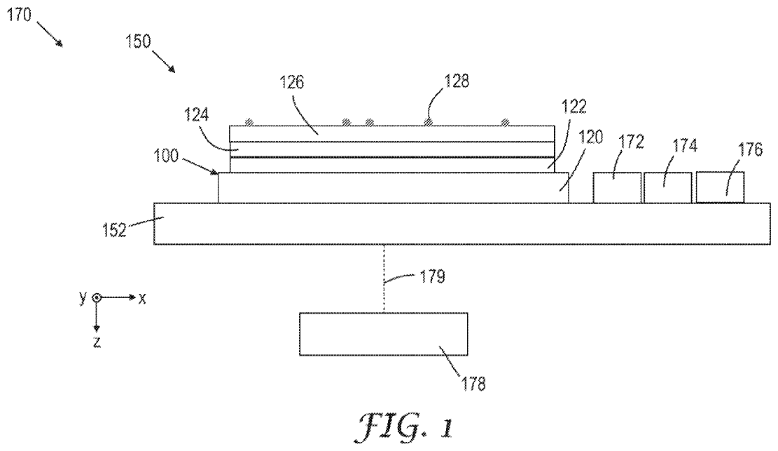

FIG. 1 is a schematic cross-section view of a system 170, a wound dressing 150, and a wearable optical analyte sensor 100, according to some embodiments. The wearable optical analyte sensor 100 includes a sensor 120 (e.g., an optical sensor and/or a pixelated image sensor), optical filter(s) 122, an illumination source 124, and an analyte-sensitive photoluminescent layer 126. The wound dressing 150 includes the wearable optical analyte sensor 100 and a wound dressing substrate 152.

Optional components 172, 174, 176 and 178 are schematically illustrated in FIG. 1. These components may include one or more of a processor, a battery or power management module, and a wireless communication module, for example. The components (e.g., 172, 174, 176) may be integrated into a same article (e.g., the wound dressing 150 or the wearable optical analyte sensor 100), or the components (e.g., 178) may be external to the wound dressing 150 and the wearable optical analyte sensor 100. A connection 179 between the component 178 and the wearable optical analyte sensor 100 may be wired or wireless. A wired connection may include a wire releasably attached to the analyte-sensitive photoluminescent layer 126 through an electrical connector (e.g., one of the components 172, 174, 176 can be an electrical connector for connecting to an external component), for example. In some embodiments, the wound dressing 150 is configured to receive power from an external power source (e.g., component 178). The external power source can include a battery and/or mains power. In some embodiments, the wound dressing 150 includes a battery (e.g., one of 172, 174, 176) disposed on the wound dressing substrate 152. The components 172, 174, 176 may be disposed directly or indirectly on the wound dressing substrate 152. For example, the components 172, 174, 176 may be disposed on a same (e.g., flexible) circuit board as the optical sensor 120 where the circuit board is disposed on the wound dressing substrate 152. Additional components may be included and disposed directly or indirectly on the wound dressing substrate 152.

In some embodiments, a response (e.g., intensity or wavelength of emitted light) of the analyte-sensitive photoluminescent layer 126 is dependent on temperature. In some embodiments, the wearable optical analyte sensor 100 further includes a temperature sensor (e.g., one of components 172, 174, 176 can be a temperature sensor). In some embodiments, the temperature sensor is one or more of a thermocouple, thermistor, a color change temperature sensor, or a photoluminescent temperature sensor. For example, in some embodiments, a photoluminescent temperature sensor can be provided by including temperature dependent photoluminescent material in the analyte-sensitive photoluminescent layer 126.

The system 170 includes the wearable optical analyte sensor 100 and a processor in (e.g., electrical or electromagnetic) communication (wired or wireless) with sensor 120. For example, in some embodiments, at least one of components 172 and 178 is or includes a processor. The processor can be configured to determine the presence of an analyte (e.g., based on data received from the optical sensor 120). In some embodiments, the processor is configured to determine a (e.g., two-dimensional) spatial distribution of the analyte (e.g., over a major surface of the analyte-sensitive photoluminescent layer 126). In some embodiments, the analyte-sensitive photoluminescent layer 126 is responsive to one or more analytes 128 selected from the group consisting of oxygen, hydrogen (e.g., pH), and carbon dioxide. The processor can be configured to determine the presence and/or spatial distribution of any one or more of these analytes. In some embodiments, the wearable optical analyte sensor 100 and the processor are disposed in a same article. In some embodiments, a battery is disposed in the same article. In some embodiments, the system 170 is configured to receive power from an external power source. In some embodiments, the wearable optical analyte sensor 100 and the processor are wired to one another. In some embodiments, the wearable optical analyte sensor and the processor are wirelessly connected to one another. Additional configurations of batteries, external power sources, processors, wired connections, and/or wireless connections can be utilized as would be appreciated by those of ordinary skill in the art.

The wound dressing 150 can include the sensor 120 disposed between the analyte-sensitive photoluminescent layer 126 and the wound dressing substrate 152. The wound dressing substrate 152 may be, for example, any substrate commonly used in wound dressings. In some embodiments, the wound dressing substrate 152 is or includes a polymeric film, for example. Suitable polymeric films include those available from 3M Company (St. Paul, MN) under the TEGADERM tradename. The wound dressing substrate 152 may be or include a barrier to environmental oxygen, for example. The wound dressing 150 can include optional additional layers (e.g., a gauze layer) as would be appreciated by those of ordinary skill in the art. The wound dressing 150 can be configured to be applied over a wound with the analyte-sensitive photoluminescent layer 126 disposed between the wound and the wound dressing substrate 152.

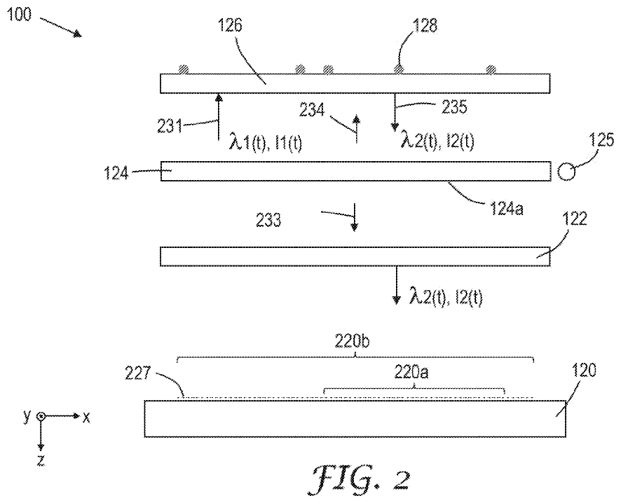

FIG. 2 is a schematic exploded view of wearable optical analyte sensor 100, according to some embodiments. The illumination source 124 emits light 231 towards the analyte-sensitive photoluminescent layer 126. In some embodiments, the illumination source 124 has an adjustable light output. The light 231 has a wavelength λ1(t) and an intensity I1(t), each of which may generally and independently depend on time, t, or may be constant. For example, the intensity I1(t) can be time dependent (e.g., modulated intensity) in measurements of lifetime. The wavelength λ1(t) can be time dependent when it is desired to (e.g., sequentially) illuminate two different phosphorescent materials at two different respective wavelengths, for example. Optical filter(s) 122 can be or include a wavelength-selective optical filter that blocks light 233 that has the wavelength λ1(t) and that may be light from the illumination source 124 that has reflected from the analyte-sensitive photoluminescent layer 126, or another layer, or that has been emitted (e.g., leaked) from a back side, for example, of the illumination source 124. The analyte-sensitive photoluminescent layer 126 emits (e.g., phosphoresces) light 235 having a wavelength λ2 (t) and an intensity I2(t) and is transmitted through the optical filer(s) 122 and, in the illustrated embodiment, through the illumination source 124 (e.g., through a light guide of the illumination source 124). The wavelength λ2(t) and the intensity I2(t), may generally and independently depend on time, t, or may be constant. For example, the quantity or type of analyte 128 at the analyte-sensitive photoluminescent layer 126 may cause one or both of the emitted intensity or wavelength to change. In some embodiments, the analyte-sensitive photoluminescent layer 126 phosphoresces when illuminated where the phosphorescence depends on the presence and/or amount of analyte 128 on the analyte-sensitive photoluminescent layer 126. For example, the intensity I2(t) and/or the wavelength λ2 (t) of the phosphorescent light can depend on the amount of analyte 128 present on the analyte-sensitive photoluminescent layer 126. The optical sensor 120 can then detect the light emitted from the analyte-sensitive photoluminescent layer 126. A processor (e.g., component 172 or 178 of FIG. 1) can receive data from the optical sensor 120 to determine whether or not the analyte 128 is present or quantify the amount or spatial distribution of the analyte 128 that is present.

In some embodiments, the processor is configured to determine the presence of the analyte 128 based, at least in part, on an intensity I2(t) of light emitted by the analyte-sensitive photoluminescent layer 126 and detected by the sensor 120. In some embodiments, the processor is configured to determine the presence of the analyte 128 based, at least in part, on a change of an intensity I2(t) of light emitted by the analyte-sensitive photoluminescent layer 126 and detected by the sensor 120. In some embodiments, the processor is configured to determine the presence of the analyte 128 based, at least in part, on a decay lifetime (e.g., determined by a decay of I2(t) with time) of light emitted by the analyte-sensitive photoluminescent layer 126 and detected by the sensor 120 when the illumination source 124 emits a modulated intensity (e.g., I1(t) can be time-dependent and modulated). In some embodiments, the processor is configured to determine the presence of the analyte 128 based, at least in part, on a wavelength λ2 (t) of light emitted by the analyte-sensitive photoluminescent layer 126 and detected by the sensor 120. In some embodiments, the processor is configured to determine the presence of the analyte 128 based, at least in part, on a change of wavelength of light λ2(t) emitted by the analyte-sensitive photoluminescent layer 126 and detected by the sensor 120. In some embodiments the sensor 120 is a pixelated image sensor. In some embodiments, the processor is configured to determine a spatial distribution of the analyte based, at least in part, on an image 227 detected by the pixelated image sensor. Determination of the presence of the analyte can include determining a partial pressure of the analyte, for example. Determination of the partial pressure of oxygen based on a phosphorescence lifetime is described in U.S. Pat. Appl. Pub. No. 2016/0338631 (Li et al.), for example.

In some embodiments, the extended illumination source 124 includes a light guide 124a. In some embodiments, the illumination source 124 includes one or more light emitting elements 125 such as one or more light emitting diodes (LEDs). The LED(s) can be disposed along an edge of a light guide 124a, for example. The one or more LEDs can be or include one or more ultraviolet (UV)-LEDs (e.g., 385 nm LEDs). In some embodiments, the illumination source 124 is configured to emit light in a wavelength range of 300 nm to 500 nm, or 320 nm to 400 nm, or 360 nm to 400 nm, or 500 nm to 600 nm, or 600 nm to 700 nm, for example. For example, the wavelength λ1 can be in this range. In some embodiments, the intensity of light emitted by the illumination source can have a peak intensity at the wavelength λ1 which can be in any of these ranges. In some embodiments, the wavelength λ2 is in a visible wavelength range (e.g., a range of 400 nm to 700 nm). In some embodiments, the wavelengths λ1 and λ2 differ by at least 10, 20, 30, 40, or 50 nm. In some embodiments, the illumination source 124 is configured to emit a first light 231 for illuminating the analyte-sensitive photoluminescent layer 126 and a second light 234 for other imaging purposes. For example, the second light 234 can be (e.g., a near-infrared light) configured to illuminate a wound (e.g., in wound dressing application) so that optical sensor 120 can obtain an image of the wound. The second light 234 can alternatively be provided by a different illumination source than the illumination source 124. In some embodiments, the analyte-sensitive photoluminescent layer 126 can be substantially transparent to the second light 234. In some embodiments, the extended illumination source 124 includes a light guide 124a. In some embodiments, the light guide 124a includes a plurality of light extraction features. Light guides with light extraction features for substantially uniformly extracting light from a major surface of the light guide are known in the art and include those described in U.S. Pat. No. 6,033,604 (Lundin et al.); 8,851,734 (Lee); U.S. Pat. No. 9,429,691 (Lee et al.); and 10,732,344 (Epstein et al.), for example. In some embodiments, the light guide 124a is substantially coextensive with the wavelength selective optical filter 122. In some embodiments, the analyte-sensitive photoluminescent layer 126 is substantially coextensive with each of the light guide 124a and the wavelength-selective optical filter 122.

Layers or elements can be described as substantially coextensive with each other if at least about 60% by area of each layer or element is coextensive with at least about 60% by area of each other layer or element. Here, area refers to the area of a major surface of the layer or element. In some embodiments, for layers or elements described as substantially coextensive, at least about 70%, or at least about 80%, or at least about 90%, or at least about 95% by area of each layer or element is coextensive with at least about 70%, or at least about 80%, or at least about 90%, or at least about 95% by area of each other layer or element. In the case of a layer of a plurality of discrete elements, the area of the layer refers to the area within an outer boundary of a region defined by the plurality of discrete elements.

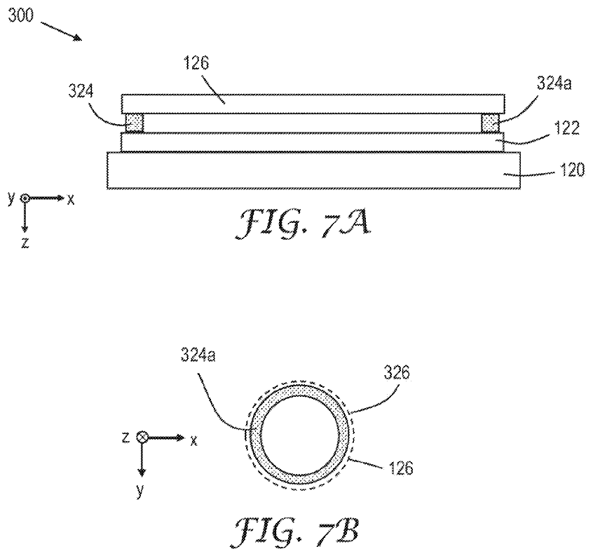

In some embodiments, a wearable optical analyte sensor 100 includes a plurality of optical elements stacked on one another along a common stacking direction (e.g., z-direction referring the x-y-z coordinate system of FIGS. 1-2, for example). In some embodiments, the plurality of optical elements includes an optical sensor 120 configured to detect light incident on the optical sensor along the stacking direction; an analyte-sensitive photoluminescent layer 126; an illumination source 124 disposed between the analyte-sensitive photoluminescent layer 126 and the optical sensor 120; and a wavelength-selective optical filter disposed between the illumination source 124 and the optical sensor 120. For example, the optical filter(s) 122 can include the wavelength-selective optical filter. In some embodiments, as described further elsewhere herein (see, e.g., FIG. 7), the plurality of optical elements alternatively, or in addition, includes an angular light control filter disposed between the illumination source 124 and the optical sensor 120. For example, the optical filter(s) 122 can include the angular light control filter. In some embodiments, the optical sensor 120 is pixelated (e.g., the optical sensor 120 can be a pixelated image sensor). In some embodiments, a wearable optical analyte sensor 100 includes a pixelated image sensor 120; an analyte-sensitive photoluminescent layer 126; an extended illumination 124 source disposed between the analyte-sensitive photoluminescent layer 126 and the pixelated image sensor 120; and a wavelength-selective optical filter 122 disposed between the extended illumination source 124 and the pixelated image sensor 120. Pixelated areas 220a and 220b of the optical sensor 120 are schematically illustrated in FIG. 2. Pixelated area 220b can be a largest active imaging area and can include pixelated area 220a. In some embodiments, each of the analyte-sensitive photoluminescent layer 126 and the wavelength-selective optical filter 122 cover at least a same first pixelated imaging area 220a, 220b of the pixelated image sensor 120. In some embodiments, the extended illumination source 124 covers at least the first pixelated imaging area of the pixelated image sensor. The first pixelated imaging area 220a can comprises at least 50% of a largest active imaging area 220b of the pixelated image sensor.

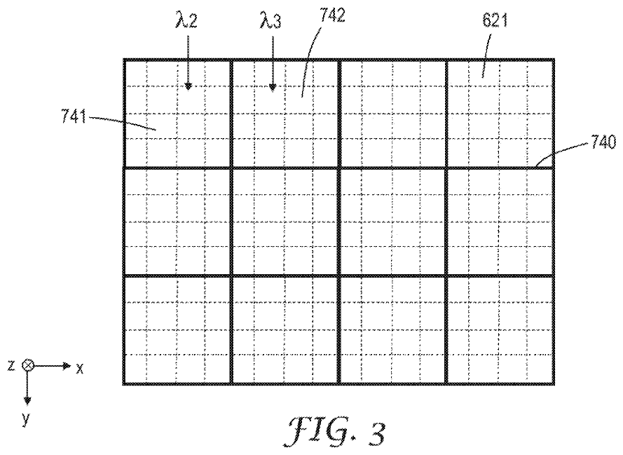

In some embodiments, the optical sensor 120 (e.g., pixelated image sensor) has a largest active imaging area (e.g., 220b) of at least 1, 2, 3, 4, or 5 cm². In some embodiments, the optical sensor 120 (e.g., pixelated image sensor) includes a plurality of pixels (see, e.g., FIG. 3), where the pixels have an average pixel area of at least 1, 5, 10, 15, 20, 25, 50, 75, or 100 μm². In some embodiments, a resolution of the pixelated image sensor is less than 1000, 500, 250, 100, 50, 20, 15, 10, 5, 3, 2, or 1 microns. In various embodiments, full resolution of the pixelated image sensor can be utilized for some measurements, or the pixels can be binned to improve the signal to noise ratio in high sensitivity measurements. In some embodiments, the pixelated image sensor can be used at a low resolution to perform medical screenings and then switched to a high resolution when imaging specific areas of concern. Suitable sensors include complementary metal-oxide semiconductor (CMOS) devices, charge-coupled devices (CCD), and organic photodiode (OPD) devices. Suitable flexible OPD-based sensors are described in “A conformable imager for biometric authentication sign measurement”; Yokota et. al.; Nature Electronics volume 3, pages 113-121 (2020); and “Organic photodiodes: printing, coating, benchmarks, and applications”; Noah Strobel et al.; 2019 Flex. Print. Electron. 4 04300, for example.

FIG. 3 is a schematic top plan view of a wearable optical analyte sensor or a portion of a wearable optical analyte sensor, according to some embodiments, showing a plurality of pixels 621 of a pixelated image sensor and a pattern 740 defining a plurality of regions 741, 742. The pattern 740 can schematically represent a patterning of an analyte sensitive photoluminescent layer or can schematically represent a patterned optical filter that defines the regions 741, 742, for example.

In some embodiments, the analyte-sensitive photoluminescent layer comprises a reference material for calibration of the wearable optical analyte sensor. For example, the regions 741 can alternate with the regions 742 (e.g., in a checker-board pattern) where the regions 742 include the reference material and regions 741 include an analyte-sensitive photoluminescent material. Alternatively, the reference material and an analyte-sensitive photoluminescent material can each be uniformly dispersed in the analyte-sensitive photoluminescent layer. In some embodiments, the reference material includes a temperature dependent photoluminescent material which can be useful when a response (e.g., intensity or wavelength of emitted light) of the analyte-sensitive photoluminescent layer 126 is dependent on temperature.

In some embodiments, the analyte-sensitive photoluminescent layer comprises an analyte-sensitive material that emits light at a first wavelength (e.g., λ2), and the reference material emits light at a different second wavelength (e.g., λ3). In some embodiments, each of the first and second wavelengths is in a range of 400 nm to 700 nm. In some embodiments, the first and second wavelengths differ by at least 10, 20, 30, 40, or 50 nm. In some embodiments, the pixelated image sensor comprises a patterned optical filter (e.g., schematically represented by pattern 740) configured to transmit the first wavelength, but not the second wavelength, to a first plurality of pixels (e.g., in regions 741) of the pixelated image sensor and to transmit the second wavelength, but not the first wavelength, to a different second plurality of pixels (e.g., in regions 742) of the pixelated image sensor.

In some embodiments, the analyte-sensitive photoluminescent layer comprises at least two different analyte-sensitive photoluminescent materials. For example, in some embodiments, the analyte-sensitive photoluminescent layer comprises a plurality of first regions 741 and a plurality of second regions 742, where the first and second regions comprise different respective first and second analyte-sensitive photoluminescent materials. Alternatively, the first and second analyte-sensitive photoluminescent materials can each be uniformly dispersed in the analyte-sensitive photoluminescent layer.

Suitable analyte-sensitive photoluminescent materials include porphyrin-based materials (e.g., for oxygens sensing) such as platinum tetrakis (pentafluorophenyl) porphyrin (available from PreSens Precision Sensing GmbH, Regensburg, Germany), for example. Suitable porphyrin-based photoluminescent materials are described in U.S. Pat. Appl. Pub. No. 2016/0338631 (Li et al.), for example. Fluorescence quenching of 8-hydroxypyrene-1,3,6 trisulfonic acid (HPTS) can be used in sensor applications for the detection of gaseous and dissolved CO₂. HPTS displays excitation and emission peaks in the visible range (excitation wavelength is 460 nm, and emission wavelength is 520 nm). Ruthenium-tris (4,7-diphenyl-1,10-phenanthroline) dichloride (Ru (dpp)) can be used as a probe for luminescent detection and quantitation of oxygen. The red fluorescence of the dye is strongly reduced by molecular oxygen due to dynamic quenching, making Ru (dpp) a useful oxygen probe based on either measurement of intensity or decay time, for example. Other metal (typically Ruthenium and Osmium) polypyridyl complexes can also be used as photoluminescent sensors of oxygen. Polycyclic aromatic hydrocarbons such as pyrene, perylene and decacyclene derivatives may be used as luminescent indicators for oxygen since they have long excited state lifetimes and can be quenched by oxygen. In addition to metalloporphyrins, cyclometallated complexes of Ir(III) and Pt(II) can also be used in oxygen sensing. Reduction of weakly fluorescent Resazurin (7-Hydroxy-3H-phenoxazin-3-one 10-oxide) to the pink-colored and highly fluorescent Resorufin (7-Hydroxy-3H-phenoxazin-3-one) by H₂ in presence of Pd/C catalyst can be used for H₂ sensing.

Suitable reference materials include photostable fluorescein, coumarins, rhodamine dyes, and other luminescent materials such as quantum dots. Such materials are known in the art and may have tailored absorption and emission properties.

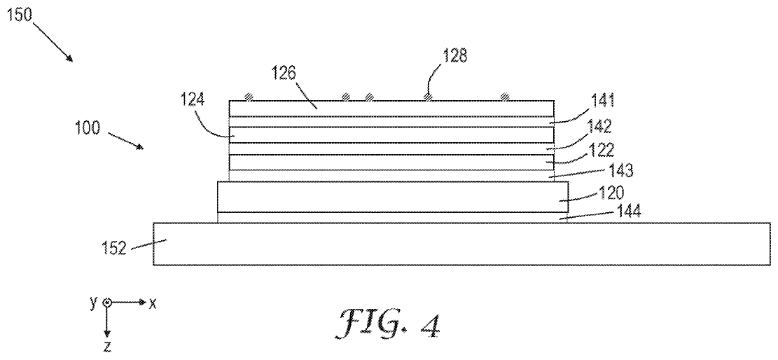

The adjacent layers of the wearable optical analyte sensor 100, or other wearable optical analyte sensors of the present description (e.g., wearable optical analyte sensors 200, 300, 400 described elsewhere herein), may be bonded together with adhesive layers. FIG. 4 is a schematic cross-sectional view of a wound dressing 150 including a wearable optical analyte sensor 100, according to some embodiments. In some embodiments, the wearable optical analyte sensor 100 includes at least one adhesive layer 141, 142, 143 disposed between the sensor 120 and the analyte-sensitive photoluminescent layer 126. An adhesive layer 144 may be disposed between the sensor 120 and the wound dressing substrate 152. In some embodiments, the at least one adhesive layer 141, 142, and/or 143 includes an optically absorptive material (e.g., a material that absorbs at some wavelengths such as 21, but that substantially transmits the wavelength λ2). In some embodiments, the adhesive layer has a refractive index between those of adjacent layers in order to reduce interface reflections. In some embodiments, for at least one wavelength in a wavelength range of 400 nm to 700 nm, the at least one adhesive layer comprises a refractive index between refractive indices of adjacent layers of the wearable optical analyte sensor 100. In some embodiments, each layer of the wearable optical analyte sensor 100 (or each layer of the wound dressing 150) is attached (e.g., bonded via an adhesive) to an adjacent layer of the wearable optical analyte sensor (or to an adjacent layer of the wound dressing 150). In some embodiments, the wearable optical analyte sensor 100 includes a plurality of optical elements stacked on one another along a common stacking direction. In some embodiments, the wearable optical analyte sensor 100 includes at least one adhesive layer 141, 142, 143 disposed between adjacent optical elements of the plurality of optical elements. In some embodiments, each optical element of the plurality of optical elements is attached to an adjacent optical element of the plurality of optical elements.

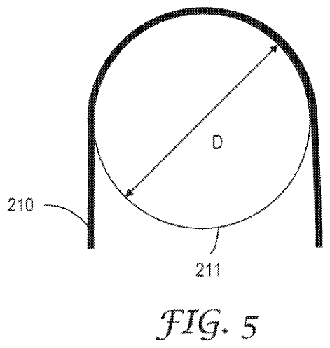

In some embodiments, the wearable optical analyte sensor 100, or other wearable optical analyte sensors of the present description (e.g., λ00, 300, 400), is flexible. In some embodiments, the sensor 120 is a pixelated image sensor. In some embodiments, the pixelated image sensor is flexible (e.g., a flexible OPD-based pixelated image sensor). FIG. 5 is a schematic cross-sectional view illustrating a flexibility of an article 210 which can correspond to the wearable optical analyte sensor 100 or to the pixelated image sensor 120, for example, according to some embodiments. The article 210 is bent around a cylinder 211 having a diameter D. In some embodiments, the pixelated image sensor 120 is sufficiently flexible that it can be bent around a cylinder having a diameter D of no more than 20 cm with little or no damage. In some embodiments, the wearable optical analyte sensor is sufficiently flexible that it can be bent around a cylinder having a diameter D of no more than 20 cm with little or no damage. The diameter D may be no more than 20, 15, 12, 10, 8, 6, 4, 3, or 2 cm, for example.

The illumination source 124 schematically illustrated in FIGS. 1, 2 and 4 can include a light guide that can be substantially coextensive with one or more of the analyte-sensitive photoluminescent sensor 126 and the optical filter(s) 122. For example, the illumination source 124 can include an edge lit light guide substantially coextensive with each of the analyte-sensitive photoluminescent layer 126 and the optical filter(s) 122, for example. Other illumination sources may alternatively be used.

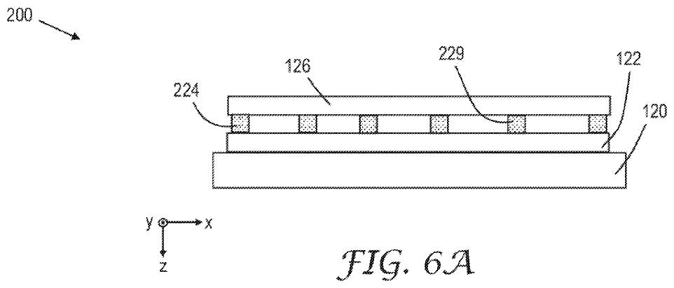

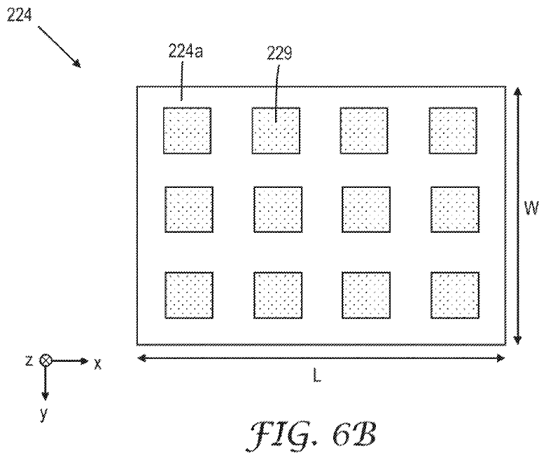

FIG. 6A is a schematic cross-sectional view of a wearable optical analyte sensor 200, according to some embodiments. The wearable optical analyte sensor 200 can correspond to the wearable optical analyte sensor 100 except that the wearable optical analyte sensor 200 includes an illumination source 224 that includes a plurality of micro-light-emitting diodes 229. FIG. 6B is a schematic top view of the illumination source 224, according to some embodiments. In some embodiments, the plurality of micro-light-emitting diodes 229 are arranged across a length L (e.g., dimension along the x-direction) and a width W (e.g., dimension along the y-direction) of a layer 224a of the micro-light-emitting diodes. In some embodiments, the analyte-sensitive photoluminescent layer is substantially coextensive with each of the layer 224a of micro-light-emitting diodes and the wavelength-selective optical filter.

FIG. 7A a schematic cross-sectional view of a wearable optical analyte sensor 300, according to some embodiments. The wearable optical analyte sensor 300 can correspond to the wearable optical analyte sensor 100 except that the wearable optical analyte sensor 300 includes an illumination source 324 includes a ring light guide 324a. FIG. 7B is a schematic top plan view of the ring light guide 324a and the analyte-sensitive photoluminescent layer 126, according to some embodiments. In some embodiments, the illumination source 324 includes a ring light guide 324a extending around a circumference 326 of the analyte-sensitive photoluminescent layer 126.

The optical filter(s) 122 can include a wavelength-selective optical filter. A wavelength-selective optical filter generally transmits light in a first predetermined wavelength range (e.g., including wavelengths emitted by the analyte-sensitive photoluminescent layer) and blocks (e.g., reflects or absorbs) light in a different second predetermined wavelength range (e.g., including wavelengths emitted by the illumination source). The first and second predetermined wavelength ranges can be non-overlapping ranges each disposed between about 300 nm and about 700 nm, or between about 350 nm and about 700 nm, or between about 360 nm and about 700 nm, for example. The transmittance and reflectance of the wavelength-selective optical filter can be substantially independent of polarization state for substantially normally incident light. The wavelength-selective optical filter can be or include a plurality or alternating first and second layers that have different refractive indices. The first and second layers can be organic or inorganic. The wavelength-selective optical filter can be or include a polymeric multilayer optical film, for example. In some embodiments, the wavelength-selective optical filter includes two or more polymeric multilayer optical films stacked on one another to block (e.g., reflect) light over a desired wavelength range. As is known in the art, multilayer optical films including alternating polymeric layers can be used to provide desired reflection and transmission in desired wavelength ranges by suitable selection of layer thicknesses and refractive index differences. Multilayer optical films and methods of making multilayer optical films are described in U.S. Pat. No. 5,882,774 (Jonza et al.); 6,783,349 (Neavin et al.); 6,949,212 (Merrill et al.); 6,967,778 (Wheatley et al.); and 9,162,406 (Neavin et al.), for example.

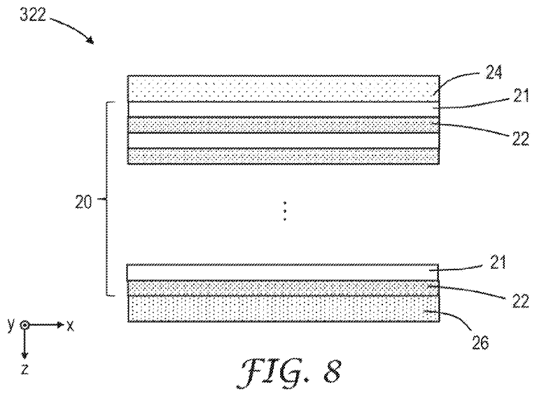

FIG. 8 is a schematic cross-sectional view of a wavelength-selective optical filter 322, according to some embodiments. The optical filter 322 includes a plurality 20 of layers disposed between first and second outer layers 24 and 26. The plurality 20 of layers can be arranged as a plurality of alternating first and second layers 21 and 22. The plurality of alternating first and second layers 21 and 22 can number at least 10, 20, 50, or 100 in total, for example. The total number of alternating first and second layers 21 and 22, and/or the total number of layers of the plurality 20 of layers, can be up to 2000, 1500, 1200, 1000, or 800, for example. Each of the first and second layers 21 and 22, and/or each layer of the plurality 20 of layers, can have an average thickness less than about 500, 400, 300, 250, or 200 nm, for example. Each of the first and second outer layers 24 and 26 can have an average thickness greater than about 500, 1000, 1500, or 2000 nm, for example. In some embodiments, the first layers 21 are birefringent and the second layers 22 are substantially optically isotropic. The polymeric layers 21, 22 may include one or more of a polycarbonate (PC), a polymethyl methacrylate (PMMA), a polyethylene terephthalate (PET), CoPMMA with PET, a glycol-modified polyethylene terephthalate (PETG), a polyethylene naphthalate (PEN), PC:PETG alloy, and a PEN/PET copolymer.

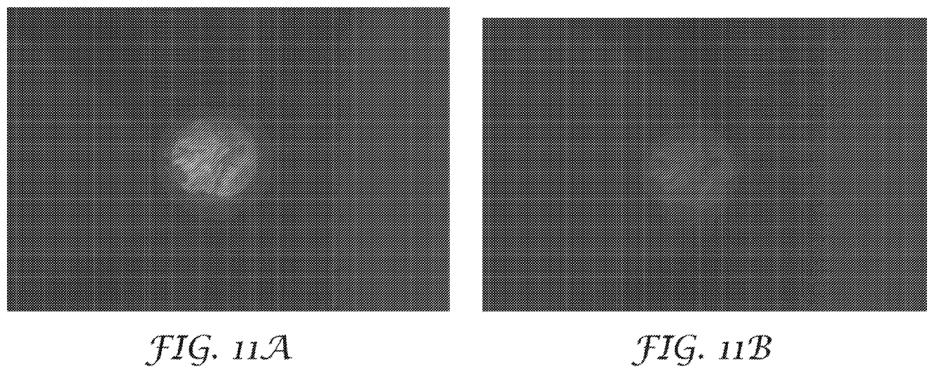

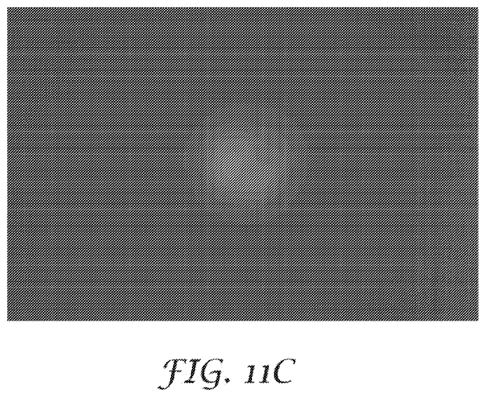

The optical filter(s) 122 can alternatively, or in addition, include an angular light control filter. An angular light control filter is an optical filter that transmits incident light in a predetermined range of incident angles (e.g., incident angles less than a predetermined value such as about 40, 30, 20, or 10 degrees, for example) and blocks incident light at other incident angles. Incident angles of light incident on the angular light control filter are generally angles between a direction of the incident light and a normal (e.g., z-direction) to the angular light control filter. It has been found that including an angular light control filter can provide improved resolution. For example, the wearable optical analyte sensor may be used to determine a two-dimensional spatial distribution of the analyte based on a two-dimensional image detected by the image sensor and including the angular light control filter has been found to improve the resolution of the two-dimensional spatial distribution of the analyte (see, e.g., FIGS. 11A-11B which show a distribution of defects in a porphyrin layer as described in the Examples, but could correspond to a two-dimensional spatial distribution of an analyte, according to some embodiments). Further, it has been found that including the angular light control filter allows the analyte-sensitive photoluminescent layer and the optical sensor to be spaced farther apart and still provide a desired resolution.

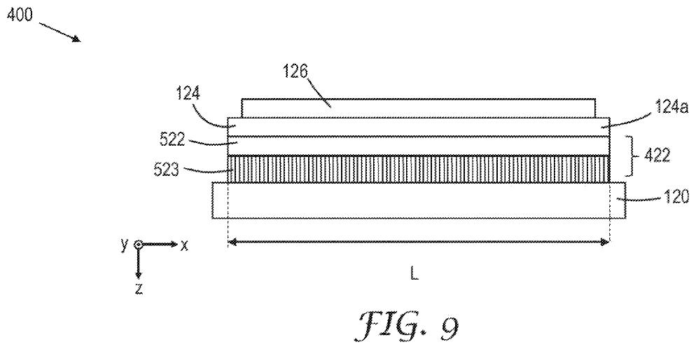

FIG. 9 is a schematic cross-sectional view of a wearable optical analyte sensor 400, according to some embodiments. The wearable optical analyte sensor 400 can correspond to the wearable optical analyte sensor 100 except that the wearable optical analyte sensor 200 includes optical filters 422 that include an angular light control filter 523 and that may also include a wavelength-selective optical filter 522. In some embodiments, the wearable optical analyte sensor 400 includes an angular light control filter 523 disposed between the (e.g., extended) illumination source 124 and the optical sensor 120 (e.g., pixelated image sensor). In some embodiments, the angular light control filter 523 is disposed between the wavelength-selective optical filter 522 and the sensor 120. In other embodiments, the wavelength-selective optical filter 522 is disposed between the angular light control filter 523 and the sensor 120. Alternatively, the wavelength-selective optical filter 522 may be omitted when the optical sensor is not responsive to wavelengths from the illumination source (e.g., when the illumination source emits UV light and the sensor is not responsive to the UV light). OPD-based sensors can be wavelength specific so as to no respond to the light from the illumination source, for example. In some embodiments, the wavelength-selective optical filter 522 is a UV blocking layer disposed (e.g., directly disposed) on the sensor 120. The illumination source 124 can alternatively be replaced by the illumination source 224 or 324, for example. The angular light control filter 523 of FIG. 9 may schematically represent a louver film or a fiber optic plate, for example. Louver films, also known as light control films, are described in U.S. Pat. No. 8,213,082 (Gaides et al.) and 9,063,284 (Jones et al.), for example. Fiber optical plates are described in U.S. Pat. No. 7,091,492 (Moonen), for example. Other suitable angular light control filters include those that include microlenses aligned with through openings in an optically absorptive layer as described in U.S. Pat. Appl. Pub. No. 2021/0271003 (Yang et al.), for example, and as described further elsewhere herein.

In some embodiments, each of the analyte-sensitive photoluminescent layer 126, the wavelength-selective optical filter 522, and the angular light control filter 523 cover at least a same first pixelated imaging area 220a (see, e.g., FIG. 2) of the optical sensor, where the first pixelated imaging area comprises at least 50% of a largest active imaging area 220b (see, e.g., FIG. 2) of the optical sensor. In some embodiments, each of the analyte-sensitive photoluminescent layer 126, the illumination source 124, the wavelength-selective optical filter 522, and the angular light control filter 523 cover at least a same first pixelated imaging area 220a of the optical sensor, where the first pixelated imaging area comprises at least 50% of a largest active imaging area 220b of the optical sensor. In some embodiments, the illumination source 124 comprises a light guide 124a substantially coextensive with each of the wavelength-selective optical filter 522 (when included) and the angular light control filter 523. In some embodiments, the analyte-sensitive photoluminescent layer 126 is substantially coextensive with each of the light guide 124a, the wavelength-selective optical filter 522 (when included), and the angular light control filter 523.

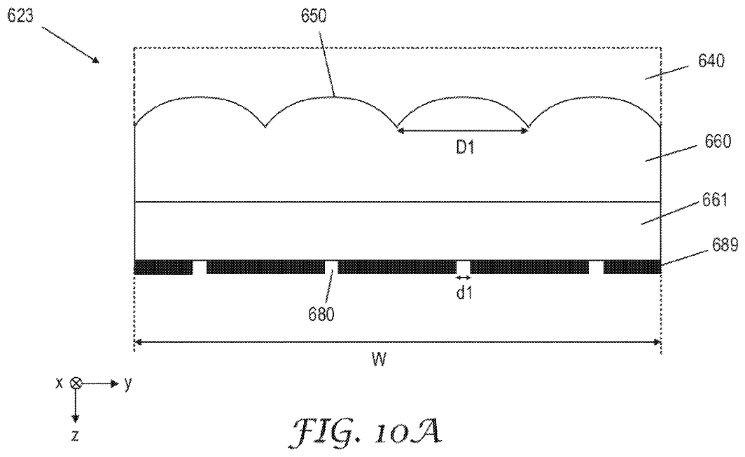

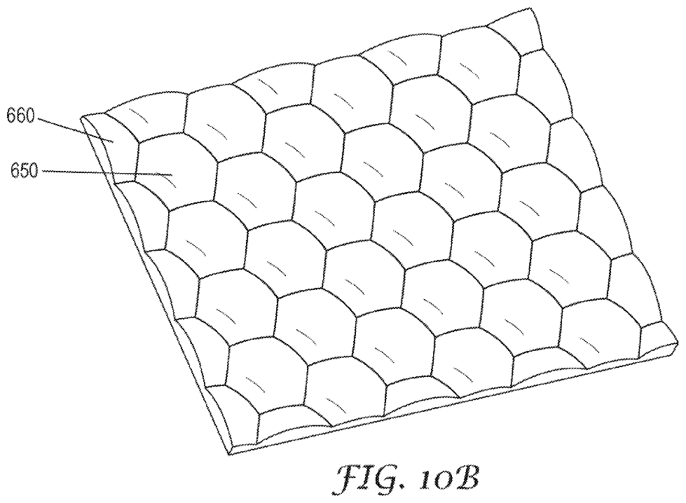

FIG. 10A is a schematic cross-section view on an angular light control filter 623, according to some embodiments. FIG. 10B is a schematic top perspective view of a plurality of microlenses 650 of the angular light control filter of FIG. 10A, according to some embodiments. The angular light control filter 623 can include a plurality of microlenses 650 arranged across a length L (e.g., dimensions along the x-direction) and a width W (e.g., dimensions along the y-direction) of the angular light control filter 623; and an optically opaque layer 689 comprising a plurality of through openings 680 therein, where the through openings 680 are arranged in one-to-one correspondence with the microlenses 650. A microlens is generally a lens having at least one lateral dimension (e.g., diameter D1) no greater than 1 mm. In some embodiments, the average diameter D1 of the microlenses is in a range of 5 micrometers to 1000 micrometers, for example. The microlenses can be arranged in a hexagonal pattern as schematically shown in FIG. 10B, for example. The optically opaque layer 689 can be disposed between the plurality of microlenses 650 and the optical sensor 120 (e.g., the angular light control filter 623 can be disposed as indicated in FIG. 9 for filter 523 and can be oriented as indicated by the x-y-z coordinate system of FIGS. 9-10A).

In some embodiments, the wearable optical analyte sensor (e.g., 400) and/or the angular light control filter 623 includes a low-index layer 640 disposed on, and substantially covering, the plurality of microlenses 650. The low-index layer 640 can have a refractive index of no more than 1.35, 1.3, 1.25, 1.2. 1.15, or 1.1 for at least one wavelength in a range of 400 nm to 700 nm. The low-index layer 640 can be included to prevent direct optical contact between the microlenses 650 and an adjacent layer (e.g., the filter 522). The low-index layer 640 can optionally be omitted. The low-index layer 640 may be a nanovoided layer as described in U.S. Pat. Appl. Publ. Nos. 2012/0038990 (Hao et al.), 2013/0011608 (Wolk et al.) and 2013/0235614 (Wolk et al.), for example. Such low-index layers may be referred to as ultra-low-index (ULI) layers.

In some embodiments, the optically opaque layer 689 comprises an optically absorptive material (e.g., pigments such as carbon black or metal oxide particles, or dyes) dispersed in a polymer. For example, the optically opaque layer 689 can be solvent deposited from a mixture of polymer, optically absorptive material dyes or pigments, and solvent which is subsequently evaporated as generally described in Int. Pat. Appl. No. WO 2021/255596 (Markowicz et al.), for example. In some embodiments, the optically opaque layer comprises a metal layer (e.g., aluminum, titanium, chromium, zinc, tin, tungsten, gold, silver, or alloys thereof). In some embodiments, the through openings 680 comprise physical through openings (e.g., physical holes that may be made in the layer 689 via laser ablation through the microlenses as generally described in U.S. Pat. No. 7,864,450 (Segawa et al.), for example). In some embodiments, the through openings comprise optical through openings (e.g., openings that allow light to be transmitted but that may not be physical holes but can be provided by modifying the material, such as by reducing a birefringence of birefringent layers of a multilayer optical film, of to allow light to be transmitted). Physical and optical through holes are described in U.S. Pat. Appl. Pub. No. 2021/0271003 (Yang et al.), for example. The through openings can have an average diameter D1 (measured in x-y plane) smaller than an average diameter d1 (also measured in x-y plane) of the microlenses by at least a factor of 5, 10, 15 or 20, for example.

In some embodiments, a polymeric layer 660 comprises the plurality of microlenses 650. The polymeric layer 660 can be formed by casting and curing the layer on a first side of the polymeric substrate 661, for example, where the optically opaque layer 689 is disposed on an opposite second side of the polymeric substrate 661. Cast and cure processes are generally described in U.S. Pat. No. 5,175,030 (Lu et al), U.S. Pat. No. 5,183,597 (Lu) and U.S. Pat. No. 9,919,339 (Johnson et al), and in U.S. Pat. Appl. Publ. No. 2012/0064296 (Walker, J R. et al), for example.

### Examples

A large area CMOS Image Sensor (Product No. S10830-71) was acquired from Hamamatsu Photonics K.K. (Shizuoka, Japan) and used to generate near-field phosphorescent images and measure oxygen concentrations. Here, the term “near-field” indicates that the phosphorescent layer was in contact or close proximity to the image sensor. The detector had 2.21 megapixels (1300× 1700) with a pixel size of 20 micrometer×20 micrometer.

Light from a 385 nm LED (M385F1, Thorlabs, Inc., Newton, NJ) was employed to excite a porphyrin sample and generate phosphorescent light. The UV light from the LED was delivered to the sample area with a 400 μm core size multimode fiber. The end of the fiber was equipped with an expander that collimated and enlarged the beam to approximately 10 mm. The sample was placed in a flow cell to control the oxygen concentration. After passing through the flow cell window, the UV light excited the porphyrin layer in the oxygen sensing/imaging construction.

The UV beam was utilized to excite the porphyrin molecules in the sensor construction and then phosphorescent light was generated. Its intensity depended on the oxygen concentration in the flow cell. The UV beam was then blocked by two multilayer optical film (MOF) filters that collectively blocked wavelengths between about 360 and 500 nm, so only the red phosphorescent light was recorded by the detector.

A commercially available platinum tetrakis (pentafluorophenyl) porphyrin (SP-PSt3-NAU-D5-YOP, cat #200000023) was acquired from PreSens Precision Sensing GmbH (Regensburg, Germany). The material was deposited by the manufacturer on a small circular substrate with a diameter of 5 mm. One side of the disks had a black coating deposited on it. The black coating was removed so that the sample could be illuminated with the UV beam and phosphorescence measurements could be performed from the opposite side in the near-field configuration. The quality of the porphyrin layer was affected by the black layer removal process. Its thickness was no longer uniform and had some defects which were visible in the images described below.

Three different oxygen concentrations were used for the experiments: 0% (pure nitrogen), 1000 ppm, and about 21% (air). After each oxygen concentration stabilized in the flow cell (4-5 minutes) phosphorescence images were recorded and later analyzed. All images were taken with a low intensity ambient light present in the lab. Images were recorded in air, in pure nitrogen, in 1000 ppm oxygen, and with the UV light source turned off. The exposure time of the image sensor was set to 5.5 ms and the current of the UV light source to 6 mA for all measurements. After the images were recorded, the average values of image sensor signal (on a 5,000 to 10,000 scale) were calculated for all pixels inside the active area of the image containing the porphyrin material and are reported in the following table.

| MEASUREMENT | AVERAGE SIGNAL |
|---|---|
| Background (UV OFF) | 5655 |
| Air atmosphere | 6332 |
| 1000 ppm oxygen | 7861 |
| Nitrogen atmosphere | 7897 |

The signal corresponding to 1000 ppm oxygen concentration is distinguishable from that corresponding to the pure nitrogen atmosphere. This difference indicates that small changes in oxygen concentration can be measured using this method.

Similar tests were repeated with an angular light control filter disposed between the MOF filters and the detector. The angular light control filter included an array of microlenses having an average pitch of about 20 microns and a polymeric optically opaque layer as generally illustrated in FIGS. 10A-10B. A 1-mm thick glass layer was disposed between the microlenses and the MOF filters. A 1-mil thick polyethylene terephthalate (PET) film was disposed between the angular light control filter and the optical sensor to protect the sensor. Results determined in nitrogen and air with the angular light control filter are shown in FIGS. 11A and 11B, respectively. Results determined in nitrogen without the angular light control filter are shown in FIG. 11C. Including the angular light control filter allowed a significantly higher resolution image of the defects in the porphyrin layer resulting from the black layer removal process.

After completing the experiments with the PreSens disk, a commercially available platinum (II) octaethylporphyrin was used to test the resolution of the construction. The oxygen sensing sample was prepared as follows: 10 mg of 2,3,7,8,12,13,17,18-Octaethyl-21H,23H-porphine, platinum (II) (available from Sigma-Aldrich, St. Louis, MO was dissolved in 2 μm of toluene in a glass vial to prepare a stock solution. This solution was coated on a 7 micrometer thick ultra-low-index (ULI) coated PET substrate using a #30 Meyer rod, where the ULI layer served as the carrier for the dye and allowed formation of a coated dye layer even in the absence of a polymeric binder or film former. The ULI coating is generally described in U.S. Pat. Appl. Publ. Nos. 2012/0038990 (Hao et al.), for example. After drying the coating in nitrogen for 5 min a second round of coating was applied again using the same solution and #30Meyer rod. The coating was dried at 70° C. in a nitrogen purged oven for 5 min.

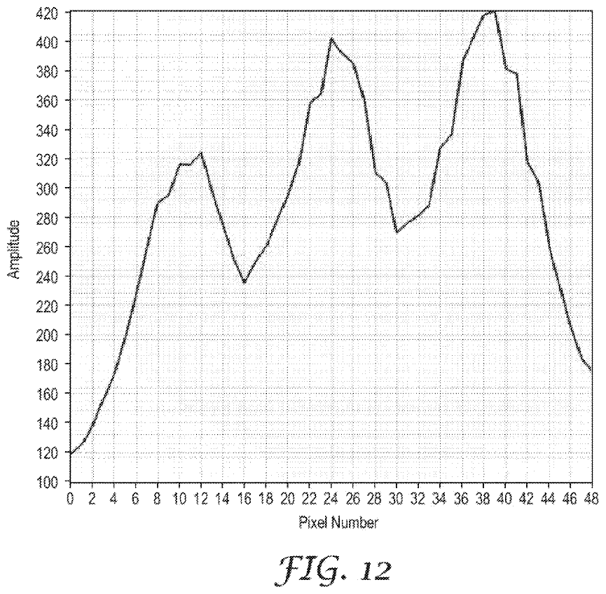

Once the sample was ready, it was used in place of the PreSens disk in the construction described previously and was then illuminated with the UV light source. A 1951 United States Air Force (USAF) resolution mask (RES-1 REV. E from Newport Corporation, Irvine, CA) was used to pattern the UV light and phosphorescence images were recorded in nitrogen and in the air atmosphere. In both cases a resolution of at least 4-line pairs per millimeter was observed. The image acquisition time was set to 700 ms and the current of the UV light source to 50 mA for the resolution measurements. FIG. 12 is a plot of the amplitude (in arbitrary units) of the signal determined in air by the optical sensor across three bright lines of the USAF mask (Group 1, Element 6 of the 1951 USAF mask which had a spatial frequency of 3.56 line pairs/mm). The amplitude of the signal from the optical sensor was proportional to the intensity of the light detected by the optical sensor. The abscissa in the plot of FIG. 12 is the pixel number when the pixels were sequentially numbered across the image and arranged at a pitch of about 20 microns.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. A wearable optical analyte sensor, comprising:
a pixelated image sensor;
an analyte-sensitive photoluminescent layer;
an extended illumination source disposed between the analyte-sensitive photoluminescent layer and the pixelated image sensor; and
a wavelength-selective optical filter disposed between the extended illumination source and the pixelated image sensor,
wherein each of the analyte-sensitive photoluminescent layer and the wavelength-selective optical filter cover at least a same first pixelated imaging area of the pixelated image sensor.

2. The wearable optical analyte sensor of claim 1, wherein the first pixelated imaging area comprises at least 50% of a largest active imaging area of the pixelated image sensor.

3. The wearable optical analyte sensor of claim 1, wherein the extended illumination source covers at least the first pixelated imaging area of the pixelated image sensor.

4. The wearable optical analyte sensor of claim 1, wherein the extended illumination source comprises a plurality of micro-light-emitting diodes.

5. The wearable optical analyte sensor of claim 1, wherein the extended illumination source comprises a light guide substantially coextensive with the wavelength-selective optical filter.

6. The wearable optical analyte sensor of claim 1, wherein the extended illumination source comprises a ring lightguide extending around a circumference of the analyte-sensitive photoluminescent layer.

7. The wearable optical analyte sensor of claim 1, further comprising an angular light control filter disposed between the extended illumination source and the pixelated image sensor.

8. A wound dressing comprising:
a wound dressing substrate; and
the wearable optical analyte sensor of claim 1 disposed on the wound dressing substrate.

9. A system comprising:
the wearable optical analyte sensor of claim 1; and
a processor in communication with the pixelated image sensor and configured to determine the presence of an analyte.

10. The system of claim 9, wherein the processor is configured to determine a spatial distribution of the analyte based, at least in part, on an image detected by the pixelated image sensor.

11. A wearable optical analyte sensor comprising a plurality of optical elements stacked on one another along a common stacking direction, the plurality of optical elements comprising:
an optical sensor configured to detect light incident on the optical sensor along the stacking direction;
an analyte-sensitive photoluminescent layer;
an illumination source disposed between the analyte-sensitive photoluminescent layer and the optical sensor; and
an angular light control filter disposed between the illumination source and the optical sensor.

12. The wearable optical analyte sensor of claim 11, wherein the plurality of optical elements comprises a wavelength-selective optical filter disposed between the illumination source and the optical sensor, wherein each of the analyte-sensitive photoluminescent layer, the wavelength-selective optical filter, and the angular light control filter cover at least a same first pixelated imaging area of the optical sensor, the first pixelated imaging area comprising at least 50% of a largest active imaging area of the optical sensor.

13. The wearable optical analyte sensor of claim 11, wherein the angular light control filter comprises:
a plurality of microlenses arranged across a length and a width of the angular light control filter; and
an optically opaque layer comprising a plurality of through openings therein, the through openings arranged in one-to-one correspondence with the microlenses, the optically opaque layer disposed between the plurality of microlenses and the optical sensor.

14. The wearable optical analyte sensor of claim 11, wherein the angular light control filter comprises a louver film or a fiber optic plate.

15. A wound dressing comprising:
a wound dressing substrate; and
the wearable optical analyte sensor of claim 11 disposed on the wound dressing substrate.
